(19) United States
(12) Patent Application Publication
(10) Pub. No.: US 2006/0176190 A1
(43) Pub. Date: Aug. 10, 2006

(54) Emergency vehicle alert system

(76) Inventor: Brian C. Madison, Brainerd, MN (US)

Correspondence Address: David O. Simmons;Galasso & Associates LP, P.O. Box 26503, Austin, TX, 78755-0503, US

(21) Appl. No.: 11/181,336

(22) Filed: Jul. 7, 2005

Related U.S. Application Data
(60) Provisional application No. 60/646,583, filed on Jan. 24, 2005.

(51) Int. Cl. G08G 1/00; B60Q 1/00; G08B 3/00

(52) U.S. Cl. 340/902; 340/691.1; 340/425.5

(57) ABSTRACT

A method for alerting a motorist of a nearby emergency vehicle comprises receiving an activation signal from a signal transmitter attached to the nearby emergency vehicle and, in response to receiving the activation signal, affecting at least one of operation of a vehicle interior lighting system and operation of a vehicle audio system. The method further comprises outputting an audible alert message in response to receiving the activation signal.

### CROSS REFERENCE TO RELATED APPLICATIONS

This patent application claims priority to co-pending U.S. Provisional Patent Application having Ser. No. 60/646,583, filed Jan. 24, 2005, entitled “EVAS (emergency vehicle alert system)”, having a common applicant herewith and being incorporated herein in its entirety by reference.

### FIELD OF THE DISCLOSURE

The disclosures made herein relate generally to methods and systems configured for alerting motorists of approaching emergency vehicles and, more particularly, to such methods and systems that incorporate transmitting signals from a transmitter for reception by a signal receiver in a motorists vehicle.

### BACKGROUND

Every motorist will have to deal with an approaching emergency vehicle at some point. It is imperative that motorists act responsibly when an emergency vehicle approaches and/or needs to pass through. Many deaths result each year due to accidents involving motorists' vehicles and emergency vehicles responding to routine calls. Many motorists are pre-occupied with other activities such as talking on a mobile phone, listening to the radio, or any number of other distracting activities. In addition, many modern vehicle manufacturers are succeeding in reducing the level of outside noise allowed inside the cabin of a vehicle. As a result, many motorists do not see or hear approaching emergency vehicles. They are oblivious to the fact that an emergency vehicle is in the vicinity and needs the motorist to safely move out of the way to allow the emergency vehicle to pass. It would be safer for motorists and emergency vehicle occupants alike if motorists knew an emergency vehicle was approaching so that they could take the appropriate action.

Requesting that motorists be more aware of the presence of emergency vehicles through the use of signs or ad campaigns is not entirely feasible. In many situations it's simply not possible for a motorist to see or hear the emergency vehicle due to no fault of their own due to any number of reasons. The emergency vehicle operator should be sure to operate all applicable visual and audible signals. But in some instances, emergency vehicles must “run dark” with no sirens or flashing lights in order to approach certain potentially hostile situations in an inconspicuous manner.

Various conventional solutions that incorporate transmitting radio frequencies from transmitters in the emergency vehicle to a receiver in the motorist's vehicle for notifying motorists of approaching emergency vehicles are known. However, due at least in part to their specific configuration, these conventional solutions risk being easily ignored if the motorist doesn't notice the incoming notification (e.g., in car noise can preclude hearing a broadcast message, the motorist does not notice a displayed visual alert, etc.). Additionally, these conventional solutions are not specifically configured for actively engaging in tasks that better enable a motorist to better hear audible alerts from an emergency vehicle. In view of these limitations, conventional solutions are less than ideal solutions

Therefore, an in-car vehicle alert system that directly and undoubtedly notifies motorists that an emergency vehicle is approaching and overcomes limitations associated with conventional solutions for notifying motorists of approaching emergency vehicles would be useful, advantageous, and novel.

### SUMMARY OF THE DISCLOSURE

Embodiments of the present invention enable motorists to be made aware of approaching emergency vehicles in a straightforward yet effective manner. More specifically, embodiments of the present invention utilize existing vehicle components to inform a motorist that one or more emergency vehicles are in their proximity. In doing so, embodiments of the present invention advantageously overcome one or more shortcomings associated with conventional methods of notifying motorists that emergency vehicles are approaching. These and other objects, embodiments advantages and/or distinctions of the present invention will become readily apparent upon further review of the following specification and associated drawings.

In one embodiment, a method for alerting a motorist of a nearby emergency vehicle comprises receiving an activation signal from a signal transmitter attached to the nearby emergency vehicle and, in response to receiving the activation signal, affecting at least one of operation of a vehicle interior lighting system and operation of a vehicle audio system. The method further comprises outputting an audible alert message in response to receiving the activation signal.

In another one embodiment, a vehicle alert module comprises an interior lighting system interface, an audio system interface, a signal emission receiver, a processor, and instruction interpretable by the processor. The interior lighting system interface is connectable to an interior lighting system of a first vehicle and is configured for enabling voltage applied to the interior lighting system to be controlled therethrough. The audio system interface is connectable to an audio system of the first vehicle and is configured for enabling at least one of a volume level of the audio system and voltage applied to the audio system to be controlled therethrough. The signal receiver is configured for receiving an activation signal transmitted by a signal transmitter attached to a second vehicle. The instructions interpretable by the processor are configured for at least one of facilitating output of an audible alert message in response to the signal emission receiver receiving the activation signal, affecting operation of the interior lighting system in response to the signal emission receiver receiving the activation signal and affecting operation of the audio system in response to the signal emission receiver receiving the activation signal.

In another embodiment, a vehicle comprises an audio system, an interior lighting system, and a vehicle alert module. The vehicle alert module comprises an interior lighting system interface, audio system interface, a signal receiver, a processor, and instructions interpretable by the processor. The interior lighting system interface is connected to the interior lighting system and is configured for enabling voltage applied to the interior lighting system to be controlled therethrough. The audio system interface connects to the audio system and is configured for enabling at least one of a volume level of the audio system and voltage applied to the audio system to be controlled therethrough. The signal receiver is configured for receiving an activation signal transmitted by a signal transmitter attached to another vehicle. Instructions interpretable by the processor are configured for at least one of facilitating output of an audible alert message in response to the signal receiver receiving the activation signal, affecting operation of the interior lighting system in response to the signal receiver receiving the activation signal and affecting operation of the audio system in response to the signal receiver receiving the activation signal.

Preferably, but not necessarily, the receiver is integrated into the motorist's vehicle's onboard electronics, thus allowing it to control certain functions of the vehicle, and the transmitter is integrated into the emergency vehicle's onboard electronics. The transmitter is configured to operate when the emergency vehicle lights are active, when the emergency vehicle siren is activated and/or when no lights and/or sirens are operable. The receiver, through its integration into the vehicle's electronics, notifies the motorist in one or more different ways that an emergency vehicle is approaching. Examples of such ways of notifying the motorist that an emergency vehicle is approaching include, but are not limited to, flashing dashboard lights, outputting audible messages, reducing the volume of the vehicle's audio system, interrupting telephone communication, or interrupting navigation system operation.

Accordingly, it is a principle object of the inventive disclosures made herein to provide at least partially overcomes limitations associated with conventional approaches for notifying motorists of approaching emergency vehicles. Specifically, notifying motorists of emergency vehicles in accordance with embodiments of the disclosures made herein ensure motorists are aware that emergency vehicles are in their proximity in a convenient, high profile and readily apparent manner. Accordingly, notifying motorists of emergency vehicles in accordance with embodiments of the present invention advantageously promote safer highways and shorter response times for emergency vehicles to respond to their calls.

Turning now to specific aspects of the present invention, in at least one embodiment, a method for alerting a motorist of a nearby emergency vehicle further comprises processing the activation signal for facilitating determination of proximity of the signal transmitter.

In at least one embodiment of the present invention, affecting operation of a vehicle interior lighting system and/or a vehicle audio system and outputting an audible alert message are performed in response to the proximity of the signal transmitter being within a prescribed range.

In at least one embodiment of the present invention, the processing the activation signal includes evaluating signal strength of the activation signal such that the proximity of the signal transmitter is derived from a level of the signal strength.

In at least one embodiment of the present invention, outputting the audible alert message includes selecting the audible alert message from a group of available alert messages dependent upon the proximity of the nearby signal transmitter.

In at least one embodiment of the present invention, affecting operation of the vehicle interior lighting system and/or operation of the vehicle audio system includes at least one of controlling dashboard lights of the vehicle interior lighting system, controlling a volume level of the vehicle audio system and controlling voltage applied to the vehicle audio system.

In at least one embodiment of the present invention, controlling dashboard lights of the vehicle interior lighting system includes varying voltage applied to at least a portion of the dashboard lights.

In at least one embodiment of the present invention, controlling the volume level of the vehicle audio system includes reducing a volume level of the vehicle audio system.

In at least one embodiment of the present invention, controlling voltage of the vehicle audio system includes selectively disrupting voltage applied to the vehicle audio system.

In at least one embodiment of the present invention, the audible output interface is configured for enabling the audible alert message to be outputted and is connectable to at least one of the audio system and a standalone audible message output device.

In at least one embodiment of the present invention, the vehicle includes a controller configured for controlling at least one of powertrain functionality, audio system functionality, security system functionality and system integration functionality and the vehicle alert module is integral with the controller.

### BRIEF DESCRIPTION OF THE DRAWINGS

FIG. 1 depicts a method for alerting a motorist of a nearby emergency vehicle.

FIG. 2 depicts an embodiment of an emergency vehicle alert system in accordance with the inventive disclosures made herein, which is configured for carrying out the method depicted in FIG. 1.

FIG. 3 depicts an emergency vehicle having the emergency vehicle alert module associated therewith and a civilian vehicle having the civilian vehicle alert module associated therewith.

### DETAILED DESCRIPTION OF THE DRAWING FIGURES

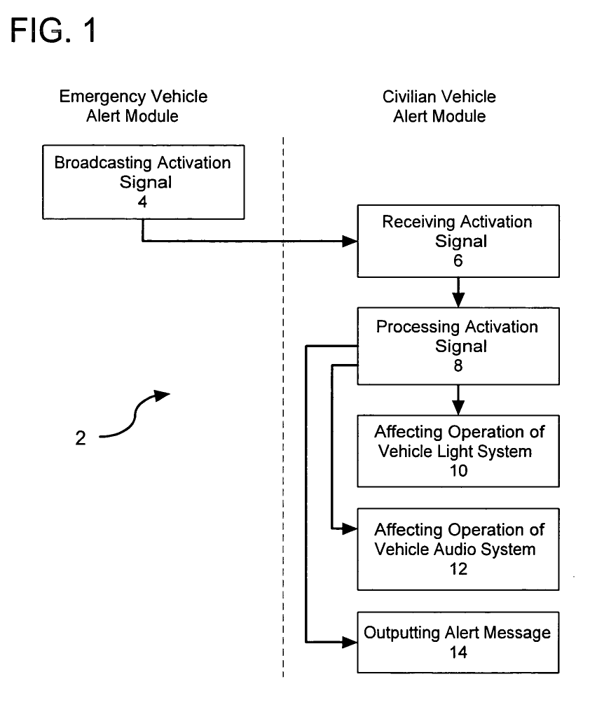

FIG. 1 depicts a method for alerting a motorist of a nearby emergency vehicle, which is referred to as the method 2. The method 2 includes an operation 4 for broadcasting an activation signal from an emergency vehicle alert module in accordance with the present invention for reception by one or more civilian vehicle alert modules in accordance with the present invention. The emergency vehicle alert module is associated with (e.g., attached to) the nearby emergency vehicle. Each civilian vehicle alert module is associated with (e.g., attached to) a respective civilian vehicle. The operation 4 for broadcasting is performed in a wireless manner and is preformed in response to any number of activation actions. Examples of such activation actions include, but are not limited to, an emergency vehicle siren being activated, emergency vehicle warning lights being activated and/or an activation button of the emergency vehicle alert module being moved to an activation position.

An operation 6 is performed for receiving the activation signal by a civilian vehicle alert module that is within a prescribed distance of the nearby emergency vehicle. In practice, all civilian vehicles equipped with a civilian vehicle alert module in accordance with the present invention will receive the activation signal and respond accordingly. In response to receiving the activation signal, an operation 8 is performed for processing the activation signal. Examples of processing the activation signal include, but are not limited to, verifying that an authentic/proper activation signal was received, facilitating determination of proximity of the signal transmitter of the nearby emergency vehicle such as by evaluating signal strength of the activation signal and determining the specific type of activation signal relative to a collection of available activation signal. After processing the activation signal, an operation 10 is performed for affecting operation of the civilian vehicle interior lighting system, an operation 12 is performed for affecting operation of the civilian vehicle audio system and an operation 14 is performed for outputting an audible alert message (e.g., via an audio system of the civilian vehicle, a standalone output device of the civilian vehicle alert module or both).

Information gathered during processing of the activation signal enables a variety of different actions taken by the civilian vehicle alert module. For example, affecting operation of the civilian vehicle interior lighting system, affecting operation of the civilian vehicle audio system and/or outputting the audible alert message may be performed dependent upon proximity of the emergency vehicle being within a prescribed range. In such an example, processing the activation signal includes evaluating signal strength of the activation signal thereby enabling proximity of the signal transmitter to be derived from a level of the signal strength. With a relative proximity of the emergency vehicle to the civilian vehicle determined, output actions by the civilian vehicle alert module may be affected dependent upon relative distance between the emergency vehicle and the civilian vehicle. For example, the rate at which and/or degree to which the civilian vehicle interior light system and/or audio system are affected may be dependent upon relative distance between the emergency vehicle and the civilian vehicle. Similarly, outputting of the audible alert message may be dependent upon relative distance between the emergency vehicle and the civilian vehicle (e.g., different messages outputted dependent upon relative distance between the emergency vehicle and the civilian vehicle).

It is disclosed herein that the emergency vehicle alert module may selectively broadcast different types of activation signals dependent upon specific types of emergency situation. In this manner, these different types of activation signals allow the civilian vehicle alert module to implement a respective type of response. For example, a first audible alert message is outputted when the emergency situation relates to a fire or a fire truck broadcasts the activation signal and a second audible alert message is outputted when the emergency situation relates to a law enforcement matter or a law enforcement vehicle broadcasts the activation signal. Thus, a motorist in a civilian vehicle in accordance with the present invention may garnish specific information dependent upon a specific type of emergency situation to which the emergency vehicle is responding.

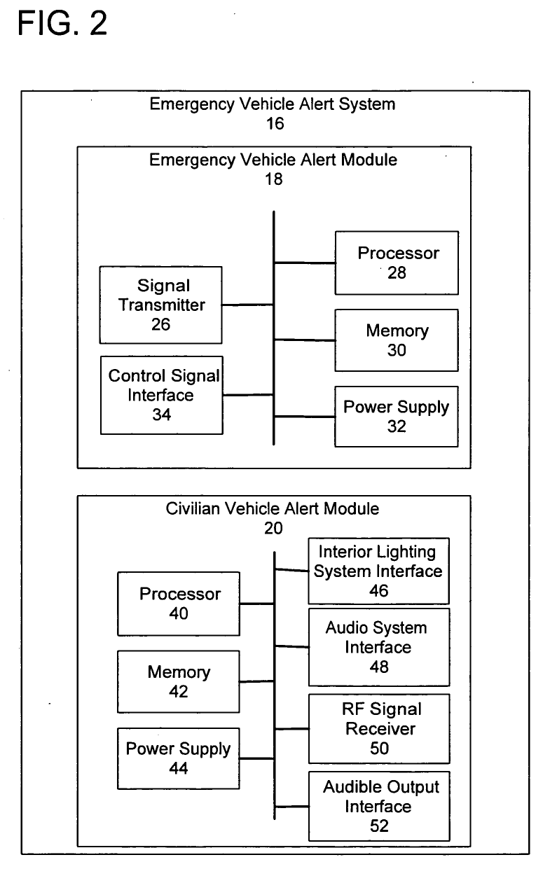

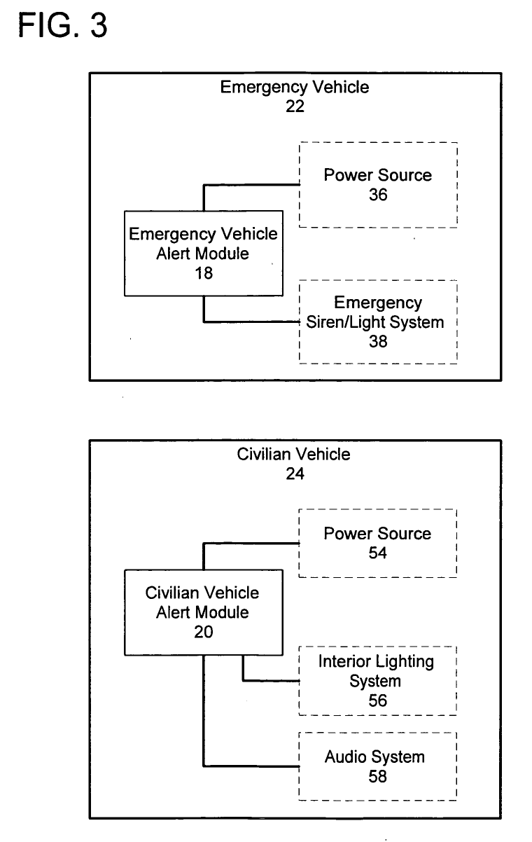

FIG. 2 depicts an embodiment of an emergency vehicle alert system in accordance with the inventive disclosures made herein, which is referred to as the emergency vehicle alert system 16 and which is capable of carrying out the method 2 discussed above in reference to FIG. 1. The emergency vehicle alert system 16 includes an emergency vehicle alert module 18 and a civilian vehicle alert module 20. FIG. 3 depicts an emergency vehicle 22 having the emergency vehicle alert module 18 associated therewith and a civilian vehicle 24 having the civilian vehicle alert module associated therewith. As discussed in greater detail below, the emergency vehicle alert module 9 and the civilian vehicle alert module 10 interact with each other even though they are not physically connected (i.e., they reside in separate vehicles and communicate information wirelessly).

Referring now to FIGS. 2 and 3, the emergency vehicle alert module 18 includes a signal transmitter 26, a processor 28, memory 30, a power supply 32 and a control signal interface 34. The signal transmitter 26, the processor 28, the memory 30, the power supply 32 and the control signal interface 34 are interconnected for enabling interaction therebetween. The power supply 32 receives power from a power source 36 of the emergency vehicle 22 (e.g., an emergency vehicle battery) and converts the power (e.g., voltage) as necessary to suitably power the signal transmitter 26, the processor 28, the memory 30 and/or the control signal interface 34. The signal transmitter 26 is configured for transmitting an activation signal for reception by the civilian vehicle alert module 20.

Instructions accessible from the memory 30 of the emergency vehicle alert module 18 are processable by the processor 28 of the emergency vehicle alert module 18. Through such accessing and processing, the processor 28 of the emergency vehicle alert module 18 is able to generate an activation signal and provide the activation signal to the signal transmitter 26 for enabling transmission of the activation signal via the signal transmitter 26. In this manner, the emergency vehicle alert module 18 is configured for transmitting an activation signal for reception by the civilian vehicle alert module 20.

Optionally, the instructions accessible from the memory 30 of the emergency vehicle alert module 18 may be configured for enabling the emergency vehicle alert module 18 to selectively broadcast different types of activation signals dependent upon specific types of emergency situation. In this manner, these different types of activation signals allow a civilian vehicle alert module 20 to implement a respective type of response. For example, a first audible alert message is outputted when the emergency situation relates to a fire or a fire truck broadcasts the activation signal and a second audible alert message is outputted when the emergency situation relates to a law enforcement matter or a law enforcement vehicle broadcasts the activation signal. Thus, a motorist in the civilian vehicle 24 may garnish specific information dependent upon a specific type of emergency situation to which the emergency vehicle 22 is responding.

A skilled person will appreciate that the signal transmitter 26 may be configured for transmitting any number of different types of signal emissions for the purpose of carrying the activation signal. Examples of such different types of signal emissions include, but are not limited to, radio waves, microwaves and radar waves. Furthermore, the skilled person will appreciate that the scope of the present invention is not necessarily limited to or by a particular type of signal emission.

The control signal interface 34 is connected to an emergency siren/light system 38 of the emergency vehicle 22 for enabling the emergency vehicle alert module 18 to be activated in response to a siren and/or lights of the emergency siren/light system 38 being activated. For example, it is disclosed herein that the emergency vehicle alert module 18 may be activated via the control signal interface 34 automatically in response to either the siren or the lights of the emergency siren/light system 10 being activated. Optionally, it is disclosed herein that the control signal interface 34 may included an activation switch for enabling activation of the emergency vehicle alert module 18 without a corresponding activation of the siren or lights of the emergency siren/light system 10.

Still referring to FIGS. 2 and 3, the civilian vehicle alert module 20 includes a processor 40, memory 42, a power supply 44, an interior lighting system interface 46, an audio system interface 48, a signal receiver 50 and an audible output interface 52. The processor 40, the memory 42, the power supply 44, the interior lighting system interface 46, the audio system interface 48, the signal receiver 50 and the audible output interface 52 are interconnected for enabling interaction therebetween. The power supply 44 receives power from a power source 54 of the civilian vehicle 24 (e.g., a civilian vehicle battery) and converts the power (e.g., voltage) as necessary to suitably power the processor 40, the memory 42, the interior lighting system interface 46, the audio system interface 48, the signal receiver 50 and/or the audible output interface 52.

The signal receiver 50 is configured for receiving the activation signal transmitted by the signal transmitter 26 of the emergency vehicle alert module 18. Accordingly, the signal receiver 50 is configured to be compatible with the signal transmitter 26. An interior lighting system 56 of the civilian vehicle 24 is connected to the civilian vehicle alert module 20 through the interior lighting system interface 46, thereby enabling the civilian vehicle alert module 20 to at least partially control operation of the interior lighting system 56 of the civilian vehicle 24. An audio system 58 of the civilian vehicle 24 is connected to the civilian vehicle alert module 20 through the audible output interface 52, thereby enabling the civilian vehicle alert module 20 to at least partially control operation of the audio system 58 of the civilian vehicle 24. The audible output interface 52 is configured for enabling an audible alert message to be outputted by the civilian vehicle alert module 20 through the audio system 58 of the civilian vehicle 24, through a standalone audible message output device such as a speaker of the civilian vehicle alert module 20 (not specifically shown) or both.

Instructions accessible from the memory 42 of the civilian vehicle alert module 20 are processable by the processor 40 of the civilian vehicle alert module 20. Through such accessing and processing, the processor 40 of the civilian vehicle alert module 20 is able to interpret the activation signal received by the signal receiver 50 and determine an appropriate alert action. Examples of such alert actions include, but are not limited to flashing all or a portion of dashboard lights by varying applied voltage, flashing all or a portion of courtesy lights by varying applied voltage, lowering a volume level of an audio system and disrupting power to an audio system. In this manner, the civilian vehicle alert module 20 is configured for receiving an activation signal, interpreting the activation signal and notifying a motorist of the presence of an emergency vehicle that transmitted the activation signal.

Optionally, the instructions accessible from the memory 42 of the civilian vehicle alert module 20 may be configured for enabling the information gathered during processing of the activation signal to influence a particular action taken by the civilian vehicle alert module. For example, affecting operation of the civilian vehicle interior lighting system 56, affecting operation of the civilian vehicle audio system 58 and/or outputting the audible alert message may be performed dependent upon proximity of the emergency vehicle being within a prescribed range. In such an example, processing the activation signal includes evaluating signal strength of the activation signal thereby enabling proximity of the signal transmitter to be derived from a level of the signal strength. With a relative proximity of the emergency vehicle to the civilian vehicle determined, output actions by the civilian vehicle alert module may be affected dependent upon relative distance between the emergency vehicle 22 and the civilian vehicle 24. For example, the rate at which and/or degree to which the civilian vehicle interior light system 56 and/or audio system 58 are affected may be dependent upon relative distance between the emergency vehicle 22 and the civilian vehicle 24. Similarly, outputting of the audible alert message may be dependent upon relative distance between the emergency vehicle 22 and the civilian vehicle 24 (e.g., different messages outputted dependent upon relative distance between the emergency vehicle 22 and the civilian vehicle 24).

Vehicle alert modules in accordance with the present invention maybe provided in a number of different formats. The particular type of format will be dependent upon the specific requirements of an application. Hence, it is disclosed herein that vehicle alert modules in accordance with the present invention are limited to any particular type of physical and/or operation configuration.

In a first format, each vehicle alert module includes an enclosure (e.g., metal or plastic) having required operational components (e.g., electronic components, hardware components, mechanical components, etc) housed therein. In this first format, connections of each vehicle alert module to the corresponding component or system of a respective vehicle is made via a respective wire and/or connector. The housing may be mounted within a cabin of the vehicle, within an engine bay of the vehicle or elsewhere on the vehicle. Preferably, but not necessarily, the housing provide impact resistance and protection against adverse environmental elements and the operational components are made in a manner that protects against failure due to vibration, adverse environmental conditions, etc. Vehicle alert modules constructed in accordance with the first format are readily configured for being retrofitted into existing vehicles or installed in new vehicles.

In another format, each vehicle alert module would be integral with one or more original equipment (OE) controllers of a respective vehicle. Examples of such OE controllers include, but are not limited to, a controller configured for controlling powertrain functionality, audio system functionality, security system functionality and/or system integration functionality. In this format, operational components of the vehicle alert modules are housed within a housing of one or more OE controllers and functionality provided by operation components of the vehicle alert module may be shared with that of one or more OE controllers. Vehicle alert modules constructed in accordance with the second format are readily configured for being integrated into new vehicles.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A method for alerting a motorist of a nearby emergency vehicle, comprising:
receiving an activation signal from a signal transmitter attached to the nearby emergency vehicle;
affecting at least one of operation of a vehicle interior lighting system and operation of a vehicle audio system, wherein said affecting is performed in response to receiving the activation signal; and
outputting an audible alert message in response to receiving the activation signal.

2. The method of claim 1, further comprising:
processing the activation signal for facilitating determination of proximity of the signal transmitter, wherein said affecting and said outputting are performed in response to the proximity being within a prescribed range.

3. The method of claim 2 wherein:
said processing includes evaluating signal strength of the activation signal; and
the proximity of the signal transmitter is derived from a level of said signal strength.

4. The method of claim 2 wherein said outputting includes selecting the audible alert message from a group of available alert messages dependent upon the proximity of the signal transmitter.

5. The method of claim 1 wherein said affecting includes controlling dashboard lights of the vehicle interior lighting system and at least one of controlling a volume level of the vehicle audio system and controlling voltage applied to the vehicle audio system.

6. The method of claim 4 wherein:
said controlling dashboard lights of the vehicle interior lighting system includes varying voltage applied to at least a portion of said dashboard lights;
said controlling the volume level of the vehicle audio system includes reducing a volume level of the vehicle audio system; and
said controlling voltage of the vehicle audio system includes selectively disrupting voltage applied to the vehicle audio system.

7. The method of claim 1, further comprising:
processing the activation signal for facilitating determination of proximity of the signal transmitter;
wherein said affecting and said outputting are performed in response to the proximity being within a prescribed range;
wherein said processing includes evaluating signal strength of the activation signal;
wherein the proximity of the signal transmitter is derived from a level of said signal strength;
wherein said outputting includes selecting the audible alert message from a group of available alert messages dependent upon the proximity of the nearby emergency vehicle;
wherein said affecting includes varying voltage applied to at least a portion of dashboard lights of the vehicle interior lighting system and at least one of controlling a volume level of the vehicle audio system and controlling voltage applied to the vehicle audio system;
wherein said controlling the volume level of the vehicle audio system includes reducing a volume level of the vehicle audio system; and
wherein said controlling voltage of the vehicle audio system includes selectively disrupting voltage applied to the vehicle audio system.

8. A vehicle alert module, comprising:
an interior lighting system interface connectable to an interior lighting system of a first vehicle and configured for enabling voltage applied to the interior lighting system to be controlled therethrough;
an audio system interface connectable to an audio system of the first vehicle and configured for enabling at least one of a volume level of the audio system and voltage applied to the audio system to be controlled therethrough;
a signal receiver configured for receiving an activation signal transmitted by a signal transmitter attached to a second vehicle;
a processor; and
instructions interpretable by the processor, wherein said instructions are configured for at least one of facilitating output of an audible alert message in response to the signal receiver receiving the activation signal, affecting operation of the interior lighting system in response to the signal receiver receiving the activation signal and affecting operation of the audio system in response to the signal receiver receiving the activation signal.

9. The vehicle alert module of claim 8 wherein:
the instructions are configured for facilitating processing of the activation signal for facilitating determination of proximity of the signal transmitter and
said affecting and said facilitating outputting are performed in response to the proximity being within a prescribed range.

10. The vehicle alert module of claim 9 wherein:
said processing includes evaluating signal strength of the activation signal; and
the proximity of the signal transmitter is derived from a level of said signal strength.

11. The vehicle alert module of claim 9 wherein said facilitating output includes selecting the audible alert message from a group of available alert messages dependent upon the proximity of the signal transmitter.

12. The vehicle alert module of claim 8 wherein:
said enabling voltage applied to the interior lighting system to be controlled includes enabling voltage applied to at least a portion of dashboard lights to be varied; and
said enabling at least one of a volume level of the audio system and voltage applied to the audio system to be controlled includes at least one of enabling a volume level of the vehicle audio system to be reduced and enabling voltage applied to the vehicle audio system to be selectively disrupted.

13. The vehicle alert module of claim 8, further comprising:
an audible output interface configured for enabling the audible alert message to be outputted and connectable to at least one of the audio system and a standalone audible message output device.

14. The vehicle alert module of claim 8, further comprising:
an audible output interface configured for enabling the audible alert message to be outputted and connectable to at least one of the audio system and a standalone audible message output device;
wherein the instructions are configured for facilitating processing of the activation signal for facilitating determination of proximity of the signal transmitter;
wherein said affecting and said facilitating outputting are performed in response to the proximity being within a prescribed range;
wherein said processing includes evaluating signal strength of the activation signal;
wherein the proximity of the signal transmitter is derived from a level of said signal strength;
said facilitating output includes selecting the audible alert message from a group of available alert messages dependent upon the proximity of the signal transmitter relative to the signal receiver;
wherein said enabling voltage applied to the interior lighting system to be controlled includes enabling voltage applied to at least a portion of dashboard lights to be varied; and
wherein said enabling at least one of a volume level of the audio system and voltage applied to the audio system to be controlled includes at least one of enabling a volume level of the vehicle audio system to be reduced and enabling voltage applied to the vehicle audio system to be selectively disrupted.

15. A vehicle, comprising:
an audio system;
an interior lighting system; and
a vehicle alert module, comprising:
an interior lighting system interface connected to the interior lighting system and configured for enabling voltage applied to the interior lighting system to be controlled therethrough;
an audio system interface connected to the audio system and configured for enabling at least one of a volume level of the audio system and voltage applied to the audio system to be controlled therethrough;
a signal receiver configured for receiving an activation signal transmitted by a signal transmitter attached to another vehicle;
a processor; and
instructions interpretable by the processor, wherein said instructions are configured for at least one of facilitating output of an audible alert message in response to the signal receiver receiving the activation signal, affecting operation of the interior lighting system in response to the signal receiver receiving the activation signal and affecting operation of the audio system in response to the signal receiver receiving the activation signal.

16. The vehicle of claim 15, further comprising:
a controller configured for controlling at least one of powertrain functionality, audio system functionality, security system functionality and system integration functionality, wherein the vehicle alert module is integral with the controller.

17. The vehicle of claim 16 wherein:
said enabling voltage applied to the interior lighting system to be controlled includes enabling voltage applied to at least a portion of dashboard lights to be varied; and
said enabling at least one of a volume level of the audio system and voltage applied to the audio system to be controlled includes at least one of enabling a volume level of the vehicle audio system to be reduced and enabling voltage applied to the vehicle audio system to be selectively disrupted.

18. The vehicle claim 17 wherein the vehicle alert module further comprises:
an audible output interface configured for enabling the audible alert message to be outputted and connectable to at least one of the audio system and an audible message output device of the vehicle alert module.

19. The vehicle of claim 18 wherein:
the instructions are configured for facilitating processing of the activation signal for facilitating determination of proximity of the signal transmitter relative to the signal receiver; and
said affecting and said facilitating outputting are performed in response to the proximity being within a prescribed range.

20. The vehicle of claim 19 wherein:
said processing includes evaluating signal strength of the activation signal; and
the proximity of the signal transmitter is derived from a level of said signal strength.
